(19) United States
(12) Patent Application Publication
(10) Pub. No.: US 2012/0052811 A1
(43) Pub. Date: Mar. 1, 2012

(54) APPARATUS AND METHOD RELATED TO ENVIRONMENTAL SPECTRUM ANALYSIS

(76) Inventors: Alexander Watson, Severn, MD (US); Sean Lane, Sykesville, MD (US); Jacinda Shelly, Odenton, MD (US)

(21) Appl. No.: 12/872,745

(22) Filed: Aug. 31, 2010

(51) Int. Cl. H04B 17/00

(52) U.S. Cl. 455/62

(57) ABSTRACT

In an embodiment of the present invention, a wide-band spectrum analyzer system uses a combination of components to achieve wide-band spectrum analysis to conduct a spectrum survey to provide an optimum selected frequency for communication. A certain frequency within a band may be identified for a mobile device, such as a cellular telephone or satellite radio system, to receive or transmit communications signals. The spectrum survey may provide a mobile network a number of frequency options. The system for conducting the spectrum survey may be stationary or mobile and may be implemented in hardware, software or a combination of hardware and software.

### BACKGROUND OF THE INVENTION

1. Field of the Invention

The present invention relates to a wide band spectrum analyzer that enables real-time frequency analysis and sharing between mobile and non-mobile radios or base stations.

2. Discussion of the Related Art

Currently, in mobile and non-mobile communications environments, transmission frequencies are preset regardless of traffic on the channel. In a dynamic or mobile communications environment, either the number of units attempting to communicate or the location of the mobile environment may result in certain frequencies becoming crowded or otherwise non-optimal for communication. The present invention offers a dynamic frequency analysis system for use in a communications network to avoid crowded/noisy channels in a real-time solution.

### SUMMARY OF THE INVENTION

Accordingly, the present invention is directed to an apparatus and method related to environmental spectrum analysis that substantially obviates one or more of the problems due to limitations and disadvantages of the related art.

An advantage of the present invention is to provide a system that allows the user to easily analyze and display a wide-band picture of the electromagnetic frequency spectrum across a larger geographic range than is traditionally provided by spectrum analyzers through the rapid collection, aggregation and processing of frequency response data across the frequency range(s) desired. The system may incorporate any desired processing of this aggregate data.

Another advantage of the present invention is to provide a system that can confirm when a system that has a “warm-up” or “boot-up” period before transmission at a specified frequency has begun transmitting

Another advantage of the present invention is to provide a system that can be used to analyze changes in spectrum usage over time at all frequencies within a specified band.

Another advantage of the present invention is to provide data transmission in any form from multiple peripherals or multiple complete transceiver systems to a central processing clearinghouse to effectively create a parallel spectrum analyzer that can perform a distributed radio frequency planning survey.

Another advantage of the present invention is the ability of multiple transmission systems operating in concert to utilize the frequencies which will provide optimum global utilization amongst all systems.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method of determining an operating frequency in a communications system in a specified environment comprising: a) selecting a spectrum to be scanned; b) receiving radio frequency (RF) signals within the selected spectrum; c) collecting data about the RF signals; d) transferring the data to a spectrum analyzer; e) performing statistical analysis on the data; f) determining an operating frequency for transmission based on a result of the statistical analysis and based on a user specified parameters for the specified environment.

In another aspect of the present invention, a wide-band spectrum analyzer system comprises a transceiver to scan and send and receive radio frequency (RF) signals; a spectrum analyzer including components to send commands to the transceiver, receive data from the transceiver, analyze the received data, and output formatted data, the components comprising: a control director to direct communication between other components; a radio/flowgraph component to control tuning of the transceiver and collect and store the raw data to be processed by the statistics component; a statistics component to perform user-requested statistics calculations on the data supplied by the radio/flowgraph component; an output component to format the data from the statistics component and output the formatted data based on user preference or requirements; a communication link to transmit data signals between the transceiver and spectrum analyzer; and a user interface to receive formatted data from the spectrum analyzer and allow a user to interface to the system.

In another aspect of the present invention, a wide-band spectrum analyzer system comprises a processing system capable of executing a system software program stored in a connected memory, communicating with a transceiver or transceivers via a communications link, and communicating with a user interface; a transceiver or transceivers connected to the processing system via the communications link, to transmit and receive RF signals, receive control commands from the processing system, send data to the processing system; a user interface communicating with the processing system to allow a user to interface with the system; and an executable system software program comprising: a radio/flowgraph component to interface the processing system to the communications link, send control commands from the processing system to the transceiver, receive data from the transceiver(s), process the data, and pass the processed data to a control director; a statistics component to receive the processed data from the control director, perform analysis to the processed data, and pass the analyzed data to the control director; an output component to receive the analyzed from the control director, and format the data for the user interface, and output the formatted data to the user interface.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating components of a wide-band spectrum analyzer according to principles of the present invention.

FIG. 2 illustrates components of the spectrum analyzer.

FIG. 3 is an exemplary flowgraph according to principles of the present invention.

FIG. 4 is a block diagram illustrating components of a wide-band spectrum analyzer of an alternative embodiment.

FIG. 5 illustrates components of an embodiment of the present invention having a virtual spectrum analyzer.

### DETAILED DESCRIPTION OF THE ILLUSTRATED EMBODIMENTS

Reference will now be made in detail to exemplary embodiments of the present invention, examples of which are illustrated in the accompanying drawings. The description below outlines the possible features of components of the spectrum analyzer system although equivalent components could also be used.

In an embodiment of the present invention, a wide-band spectrum analyzer system uses a combination of components to achieve wide-band spectrum analysis to conduct a spectrum survey to provide a selected frequency for communication in a licensed or unlicensed environment. In a licensed environment, a certain frequency within a licensed band may be identified for a mobile device, such as a cellular telephone or satellite radio system, to receive or transmit communications signals. In an unlicensed environment, such as a combat theater or other location without spectrum licensing or regulation, the spectrum survey may provide a mobile network any of a number of frequency options. The system for conducting the spectrum survey may be stationary or mobile and may be implemented in hardware, software or a combination of hardware and software. Embodiments may include other functionality as advantageous.

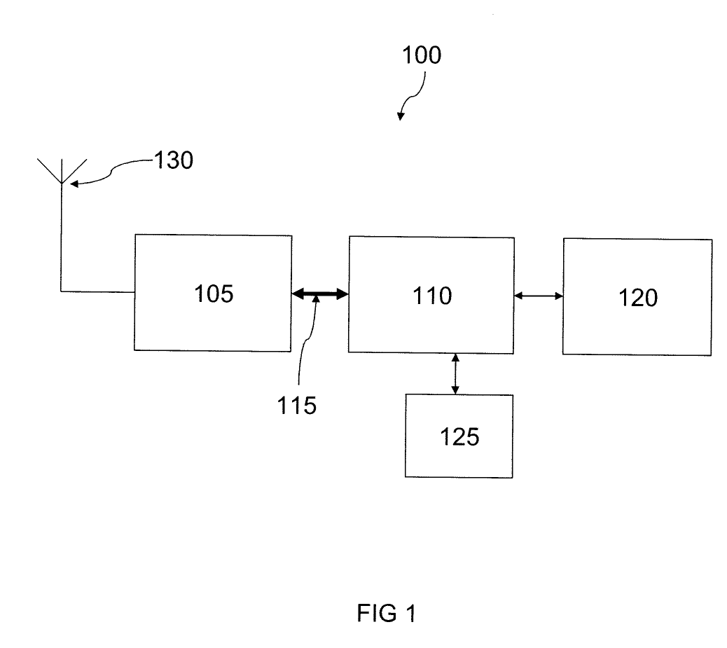

For example, a spectrum analyzer system according to principles of the present invention may be implemented using hardware components such as a Universal Software Radio Peripheral (USRP) system or equivalent. A digital spectrum analyzer may collect samples of signal data from the electromagnetic spectrum to which the analyzer is tuned. Signal samples may be analyzed to establish a spectrum pattern. For example, the system may perform Fourier Transform calculations on signal samples collected. The system may then format the result into data arrays and may perform statistical analysis on this data. The output of the system may result in the analysis being provided to a user, who reconfigures the system based on the analysis, or the system may automatically reconfigure the system parameters, including the transmission frequencies, based on the analysis. Exemplary embodiments of the current invention will be described in detail with reference to FIGS. 1-5.

FIG. 1 is a schematic block diagram of the major components of an exemplary wide-band spectrum analyzer system 100 according to principles of the present invention. The system 100 may include a transceiver 105, a spectrum analyzer 110, a communications link 115, a user interface 120, and a memory 125. Optionally, the system 100 may further include an antenna 130.

The transceiver 105 may be capable of scanning and sending and receiving radio frequency (RF) signals. The transceiver 105 scans samples from the electromagnetic spectrum in bands to which the spectrum analyzer system is tuned. Maximum and minimum scanned radio frequencies may be selected. Frequency selection and tuning may be accomplished by design or directed by the user. The transceiver 105 may be capable of performing multiple sending and receiving functions over the same or separate frequency ranges simultaneously in real time. The transceiver 105 may be configured from hardware components of a Universal Software Radio Peripheral (USRP), but is not limited thereto, and perform signal up and down conversion, amplification, mixing, tuning, decimation, filtering, and processing as is known in the art. The transceiver 105 may further perform high-bandwidth signal processing (analog-to-digital or digital-to-analog), and transmission of data to and from the spectrum analyzer 110 via a communications link 115. The physical capabilities of the transceiver used by the spectrum analyzer are the only limitations on the minimum and maximum frequencies analyzed by the system. As would be appreciated by one of ordinary skill in the art, the capabilities of this spectrum analyzer transceiver may increase over time as technology improves.

An antenna 130 or multiple antennas connected to the transceiver 105 may be used to increase transceiver 105 transmission and receiving range, minimize signal loss and noise, or direct signals in physical space. The antenna 130 can be a dipole, logarithmic, log-periodic, Yagi, parabolic, array or any other configuration known in the art. The antenna 130 connection to the transceiver can be made through a transmission line feed as also known in the art.

As illustrated in FIG. 1, the transceiver 105 is connected to the spectrum analyzer 110 via a communications link 115. The spectrum analyzer 110 may be hardware dedicated to analyzing the frequency spectrum or may be a virtual spectrum analyzer implemented in a dedicated processing system or in a shared processing system. The communications link 115 transfers digital data between the transceiver 105 and the spectrum analyzer 110. The digital data transferred may be signal data or control commands. This link may be accomplished using any serial or parallel data transmission protocol which may include RS-232, RS-422, USB, Ethernet, FireWire, IEEE 1284, SCSI, wireless, or other proprietary interface.

A control system is available to issue commands, process the signals sent to and from the transceiver, and format information for a user interface. The control system may be a separate component or resident on a shared processing system. The processing system may be configured from any components capable of performing these functions and interfacing to the other components as illustrated in FIG. 1.

The user interface 120 allows a spectrum analyzer system user to communicate with the spectrum analyzer 110 to input commands or data and receive visual, audible, or tactile information or feedback as necessary to configure or operate the system. The user interface 120 may include any combination of keyboard, key pad, mouse, trackball, touch screen, display monitor, speaker, or any other input/output device known in the art. Information and data can be communicated between the spectrum analyzer 110 and user interface 120 using any number of standard or proprietary data transmission protocols appropriate to the spectrum analyzer.

There may be one or more user interface 120. Multiple user interfaces 120 may be in communication with the spectrum analyzer 110 and/or with other user interfaces 120. Multiple user interfaces 120 may be in parallel communication with the spectrum analyzer 110, may be serially connected in daisy chain fashion, or may be connected through a network.

In an example, the wide-band spectrum analyzer is able to take as input a range or multiple ranges of frequencies to be scanned, along with a frequency step size and other parameters. The maximum and minimum values for the range(s) provided and frequency step size depend only on the capabilities of the transceiver used for tuning and sampling the spectrum.

The spectrum range is scanned beginning with the first frequency value provided. Scanning is performed at each step value of frequency until the last frequency is reached. At each step, the Fourier Transform of the scanned data stream may be computed. This scanning may occur across a single provided range or across multiple provided ranges. If multiple ranges are specified, the system may scan each range sequentially or may scan multiple frequency ranges in parallel up to the number of transceivers the hardware possesses.

After sampling is complete, the outputs are aggregated in order to produce a wide-band analysis that characterizes the frequency ranges provided in any way desired. This analysis may be provided to the user in any form including textual or graphical or otherwise. This output can include information about frequency response, noise, distortion, power, signal-to-noise ratio across the entire specified spectrum range(s), or any other analysis that could be computed based on the sampled data, including the use of machine learning or artificial intelligence algorithms. Additionally, the aggregate data analysis can be conducted and presented to the user in real-time. In this case, the system continuously scans through the range(s) specified and updates the data presented to the user in real time or close to real time.

Analysis of spectrum characteristics can also be conducted on data aggregated from different times or collection periods, or different devices/systems. This aggregated data may have data-mining, statistical, machine learning, artificial intelligence or other techniques applied to it in order to discover patterns or provide information to the user.

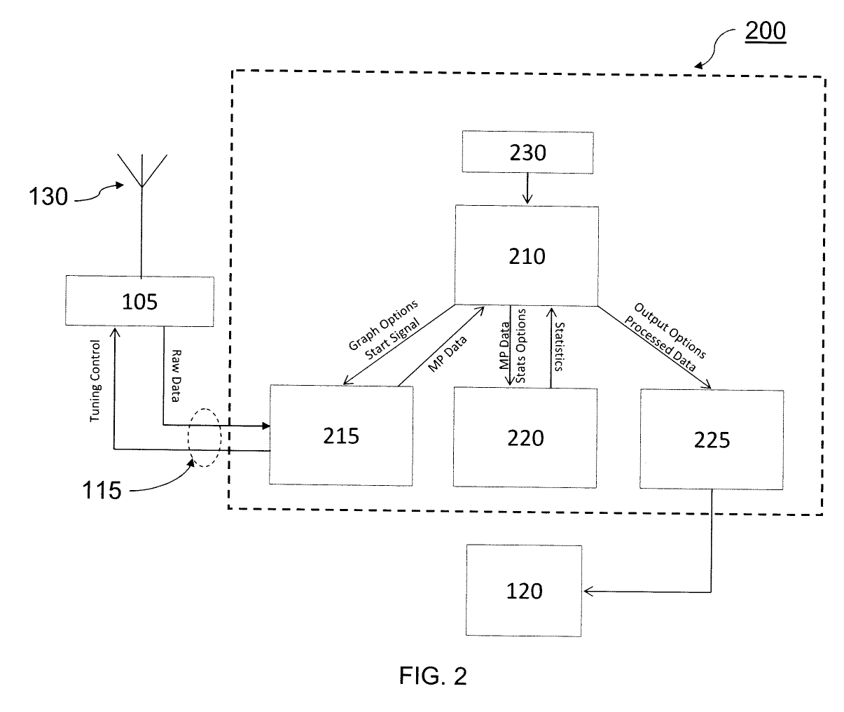

Turning now to FIG. 2, a spectrum analyzer system 200 may be divided into primary functional components performed by a dedicated processing system or by a shared processing system. These may include the control director 210, radio/flowgraph component 215, statistics component 220, and output component 225 as shown in FIG. 2. User configuration requirements 230 may also be taken into account by the system. These components and their functions are further described below.

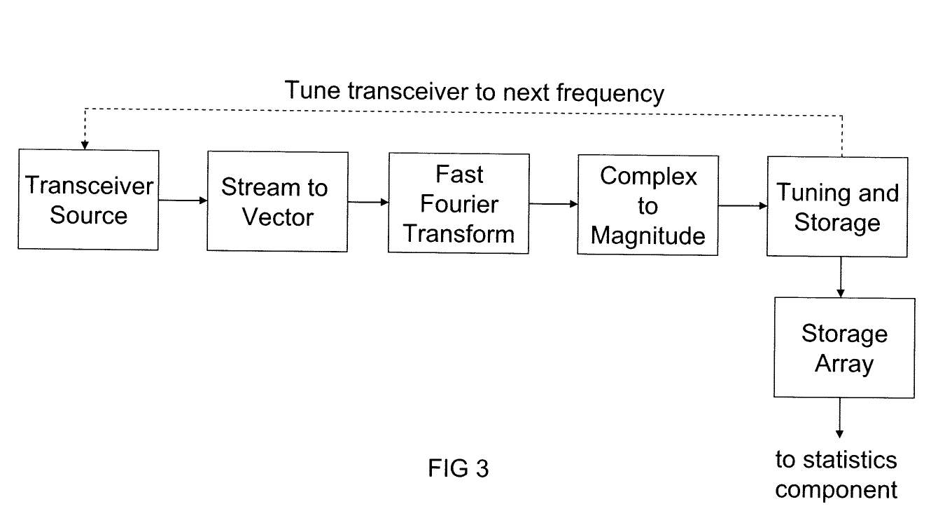

A control director 210 directs other components and handles communication between all components. The control director 210 is responsible for parsing the configuration data 230, if available, to determine the user options and passing the correct information to the other components. In a default configuration, the control director 210 directs the radio/flowgraph component 215 to build a standard flowgraph, as further discussed in relation to FIG. 3. It would then direct the radio/flowgraph component 215 to begin running and return this intermediate data to the control director 210. The control director 210 passes this data to the statistics component 220 along with user statistics preferences and the statistics component returns processed data. The control director 210 then forwards the processed data and output options to the output component 225, which formats the data appropriately for the user interface 120.

A radio/flowgraph component 215 controls tuning of the transceiver 105 over the specified range and at the specified interval and collects and stores the raw data to be processed by the statistics component 220. The radio/flowgraph component 215 may be implemented according to a software defined radio system such as GNU radio signal processing blocks or other equivalent signal processing components in conjunction with a transceiver. The transceiver 105 interfaces with the spectrum analyzer 200 through the radio/flowgraph component (flowgraph refers to a signal processing flowgraph, as exemplified in FIG. 3). The radio/flowgraph component is responsible for automatically tuning the transceiver to the correct frequency of interest and receiving the raw streamed data from the transceiver. The flowgraph performs a statistical analysis, such as a Fourier transform (FT), on the data and outputs this data into arrays or other appropriate data structures. These data structures are then passed to the control director 210, which then passes them to the statistics component 220.

An exemplary system flowgraph diagram, shown in FIG. 3, illustrates the system signal processing functions, as performed in the radio/flowgraph component 215. For example, the flow displayed begins by accepting a stream of data from the transceiver 105 over the communications link 115. In this example, this data is passed to a function that converts the stream data to vector data for performing a Fourier Transform on the data using a windowing function that can be specified by the user. Optionally, the next function converts the FT data from complex values to real (magnitude) values.

The next function in the exemplary flowgraph takes as input the location of the message queue where it is to store vector data, the time it is to spend before implementing a tuning function, and the tuning function itself. After sampling data for a set amount of time at a certain frequency, the transceiver is tuned to the next frequency where data is to be sampled. The FT magnitude data is passed to the queue and stored in an array. Once range and increment parameters are passed to the flowgraph component, the flowgraph cycles through the entire range(s) without needing additional input from the control director. Tuning and storage functions could also be performed by the control director.

This in no way exemplifies the sole way the signal data could be processed by the spectrum analyzer system. For instance, signals may be processed entirely in the real domain, and then conversion from complex to magnitude would not be necessary.

A statistics component 220 performs user-requested statistics on the gathered data and returns the processed data to the control director 210. The statistics component 220 further analyzes the data that the radio/flowgraph component 215 provides to the control director 210. The statistics component 220 may calculate, for one or a series of frequencies in selected ranges, the average and standard deviation of power detected in a band around each selected frequency. If calculated for multiple related frequency ranges (e.g. related uplink and downlink frequencies), the corresponding bands may also be averaged. Alternatively, the statistics component 220 may then rank the frequency bands, e.g., from lowest to highest, and output this ranking to the control director 210. The control director 210 could then direct this data to the output component 225 and on to the user interface 120 to allow the user to determine the most and least clogged channels at specified frequencies or ranges. The statistics component 220 may further perform any calculation, statistical analysis, or manipulation that could be conceived for arrays or streams of data.

An output component 225 controls the format of the data output based on user preference or requirements. The output may include a command-line, graphical, or sensory user interface.

The output component 225 receives data and user preference information from the control director 210. The output component 225 may also sense the connected user interface 120, format the data in a manner compatible with the user interface 120, and output the data to the user interface 120 in accordance with the format selected. One criterion for selecting a transmission frequency may be based on detected power. For example, the output component 225 may be capable of recommending to a user a transmission frequency corresponding to one in which the least amount of power is currently detected. In another mode, the output component 225 outputs data capable of a graphical display of data which may show the state of the entire scanned spectrum, scanning parameters, or any processed data. The outputs may be updated periodically with new data over time.

A configuration file 230 allows users the ability to control various options within the spectrum analyzer 200 including frequencies to be scanned, statistics to be performed, output formatting, and other transceiver control parameters. These user controlled parameters may include the frequency ranges to be scanned; the number of times each range should be scanned; the gain of the transceiver; the offset between ranges to be scanned; the channel bandwidth required for a transceiver application; the frequencies which should be compared to determine minimal current usage; the FT parameters; and whether real-time scheduling should be used. Multiple configuration files 230 may be used to define any combination of operational or output formatting parameters.

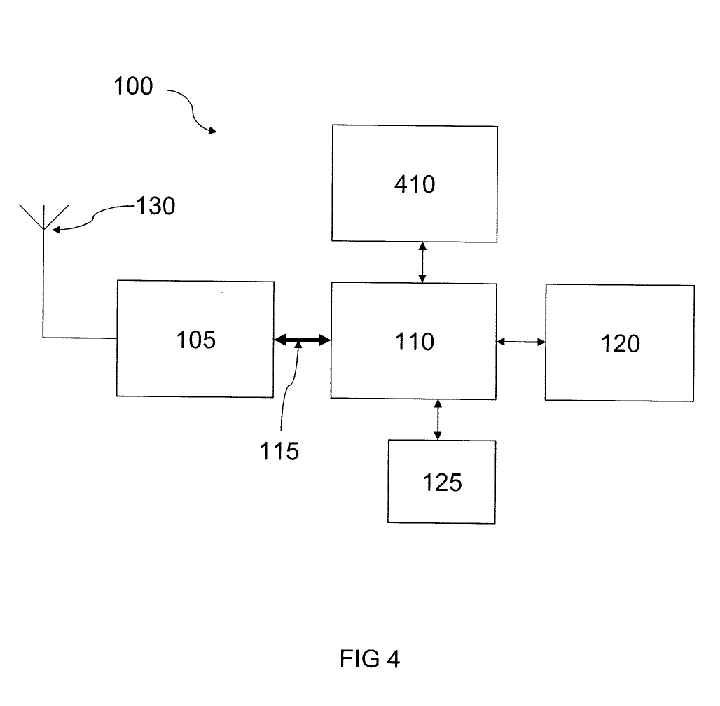

A block diagram of an alternate embodiment is illustrated in FIG. 4. As shown in FIG. 4, a command center 410 is included in the spectrum analyzer system 100. The command center 410 performs several functions of the spectrum analyzer 110 remotely such that this portion of the system is now virtual such that multiple instances of the spectrum analyzer system are running on a single computing system of one or more processors through the use of multi-threading, parallel processing, virtual machines, or equivalent method. The command center 410 may aggregate data from a network of one or more spectrum analyzers 110. The command center 410 also may communicate with components of one or more spectrum analyzers 110. Results of the analysis performed by command center 410 may used to optimize frequency allocations between one or more networked radios separated by any physical distance.

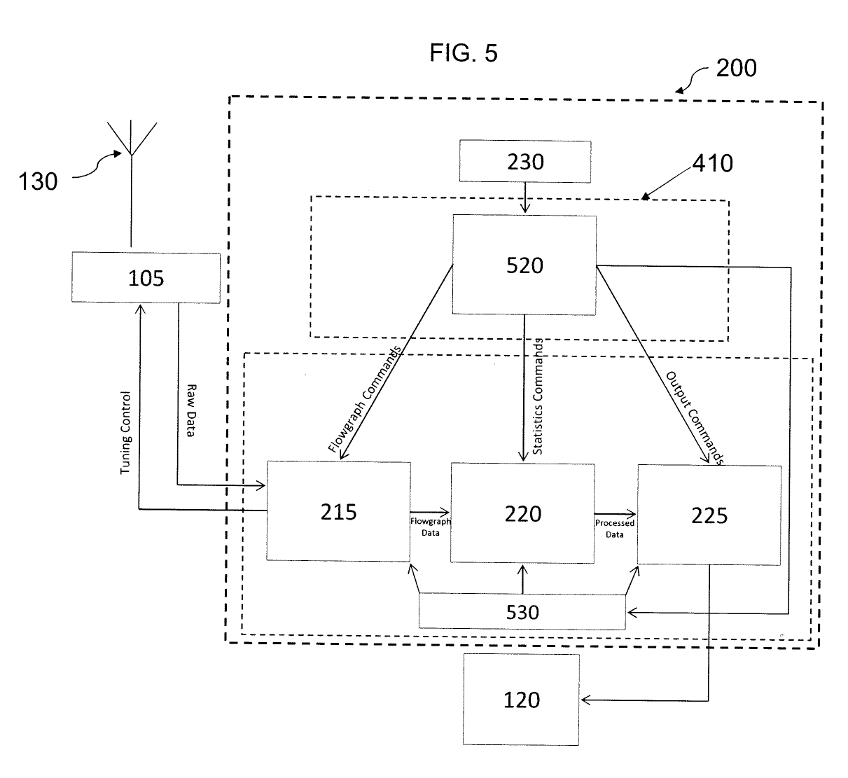

As shown in FIG. 5, the command center includes the command structure 520. The command structure 520 sends user commands and control commands to interface with the radio/flowgraph component 215, the statistics component 220, and the output component 225. The command structure 520 commands may initiate the various component functions or change user configuration. The user configuration may be changed on a real time basis.

In this embodiment, the radio/flowgraph component 215 communicates directly with the statistics component 220. The statistics component 220 communicates directly with the output component 225. Also, as illustrated in FIG. 5, the command structure 520 communicates with a user configuration component 530 which in turn communicates user configuration information to the radio/flowgraph component 215, the statistics component 220, and the output component 225.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of determining an operating frequency for a communications system in a specified environment comprising:
a) selecting a spectrum to be scanned;
b) receiving radio frequency (RF) signals within the selected spectrum;
c) collecting data about the RF signals;
d) transferring the data to a spectrum analyzer;
e) performing statistical analysis on the data; and
f) determining an operating frequency for transmission based on a result of the statistical analysis and based on a user specified parameters for the specified environment.

2. The method of claim 1, wherein the collecting step is performed by a transceiver.

3. The method of claim 2, further comprising:
the transceiver performing multiple sending and receiving operations over multiple frequencies simultaneously.

4. The method of claim 2, wherein the transceiver comprises a universal software radio peripheral.

5. The method of claim 2, further comprising:
the transceiver performing analog to digital signal processing of select signals of the RF signals.

6. The method of claim 1, wherein the receiving of RF signals is performed using an antenna.

7. The method of claim 1, wherein the statistical analysis is performed for each of a plurality of step-values of a selected frequency range.

8. The method of claim 1, further comprising:
providing information about the RF signals to a user.

9. The method of claim 8, wherein the information about the RF signals includes one of response, noise, distortion, power, or signal to noise ratio,

10. The method of claim 1, further comprising:
performing steps a-f for a predetermined time period and changing the operating frequency of one or more radios when the determining step determines a different operating frequency than the prior performance of steps a-f.

11. The method of claim 1, further comprising:
performing steps a-f for a predetermined number of times and changing the operating frequency of one or more radios when the determining step determines a different operating frequency than the prior performance of steps a-f.

12. The method of claim 1, wherein one of the user specified parameters is minimum power.

13. A wide-band spectrum analyzer system comprising:
a transceiver to scan and send and receive radio frequency (RF) signals;
a spectrum analyzer including components to send commands to the transceiver, receive data from the transceiver, analyze the received data, and output formatted data, the components comprising:
a control director to direct communication between other components;
a radio/flowgraph component to control tuning of the transceiver and collect and store the raw data to be processed by the statistics component;
a statistics component to perform user-requested statistics calculations on the data supplied by the radio/flowgraph component;
an output component to format the data from the statistics component and output the formatted data based on user preference or requirements;
a communication link to transmit data signals between the transceiver and spectrum analyzer; and
a user interface to receive formatted data from the spectrum analyzer and allow a user to interface to the system.

14. The system of claim 13 further comprising:
an antenna connected to the transceiver.

15. The system of claim 13, wherein the user interface includes an electronic display device.

16. The system of claim 13, wherein the transceiver is configured as a software defined radio system.

17. The system of claim 13, wherein the communications link is serial.

18. The system of claim 13, wherein the system software program further comprises a user configuration module to operate parameters from user selected inputs.

19. The system of claim 13, further comprising:
a memory in communications with the spectrum analyzer.

20. A wide-band spectrum analyzer system comprising:
a processing system capable of executing a system software program stored in a connected memory, communicating with transceiver via a communications link, and communicating with a user interface;
a transceiver connected to the processing system via the communications link, to transmit and receive RF signals, receive control commands from the processing system, send data to the processing system;
a user interface communicating with the processing system to allow a user to interface with the spectrum analyzer system; and
an executable system software program comprising:
a radio/flowgraph module to interface the CPU to the communications link, send control commands from the CPU to the transceiver, receive data from the transceiver, process the data, and pass the processed data to a control module;
a statistics module to receive the processed data from the control module, perform analysis to the processed data, and pass the analyzed data to the control module; and
an output module to receive the analyzed from the control module, and format the data for the user interface, and output the formatted data to the user interface.
